(19) United States
(12) Patent Application Publication
(10) Pub. No.: US 2025/0024151 A1
(43) Pub. Date: Jan. 16, 2025

(54) Electromagnetic MEMS Assembly

(71) Applicant: MEMS DRIVE (NANJING) CO., LTD., NANJING (CN)

(72) Inventors: Matthew Ng, Rosemead, CA (US); Guiqin Wang, Arcadia, CA (US)

(21) Appl. No.: 18/771,908

(22) Filed: Jul. 12, 2024

Related U.S. Application Data
(60) Provisional application No. 63/513,216, filed on Jul. 12, 2023.
(60) Provisional application No. 63/520,416, filed on Aug. 18, 2023.

(51) Int. Cl. H04N 23/68; G02B 5/20; H02K 41/035; H04N 23/55

(52) U.S. Cl. CPC H04N 23/689; H02K 41/0354; H04N 23/55; G02B 5/208

(57) ABSTRACT

An electromagnetic MEMS optical image stabilization camera module includes: a lens barrel assembly; an IR+magnet holder subassembly, wherein the IR+magnet holder subassembly includes: one or more magnet assemblies; a CIS+OIS subassembly, wherein the CIS+OIS subassembly includes: a camera image sensor; a metal spring assembly configured to enable planar motion of the camera image sensor, and one or more OIS coils configured to enable planar movement of the metal spring assembly; and an RFPCB subassembly.

### RELATED CASE(S)

This application claims the benefit of U.S. Provisional Application No. 63/513,216 filed on 12 Jul. 2023 and U.S. Provisional Application No. 63/520,416 filed on 18 Aug. 2023; the contents of which are incorporated herein by reference.

### TECHNICAL FIELD

This disclosure relates to actuators in general and, more particularly, to miniaturized electromagnetic MEMS actuators configured for use within camera packages.

### BACKGROUND

As is known in the art, actuators may be used to convert electronic signals into mechanical motion. In many applications such as e.g., portable devices, imaging-related devices, telecommunications components, and medical instruments, it may be beneficial for miniature actuators to fit within the small size, low power, and cost constraints of these application.

Micro-electrical-mechanical system (MEMS) technology is the technology that in its most general form may be defined as miniaturized mechanical and electro-mechanical elements that are made using the techniques of microfabrication. The critical dimensions of MEMS devices may vary from well below one micron to several millimeters. In general, MEMS actuators are more compact than conventional actuators, and they consume less power.

### SUMMARY OF DISCLOSURE

In one implementation, an electromagnetic MEMS optical image stabilization camera module includes: a lens barrel assembly; an IR+magnet holder subassembly, wherein the IR+magnet holder subassembly includes: one or more magnet assemblies; a CIS+OIS subassembly, wherein the CIS+OIS subassembly includes: a camera image sensor; a metal spring assembly configured to enable planar motion of the camera image sensor, and one or more OIS coils configured to enable planar movement of the metal spring assembly; and an RFPCB subassembly.

One or more of the following features may be included. The lens barrel assembly may include one or more lens assemblies. The CIS+OIS subassembly may further include one or more of: an IR filter glass assembly; a holder assembly; and a top magnetic steel assembly. The IR filter glass assembly may be configured to filter IR light passing through the lens barrel assembly. The holder assembly may be configured to position the IR filter glass assembly with respect to the lens barrel assembly. The IR+magnet holder subassembly further may include one or more of: wire bonds; moving magnetic steel; OIS drivers; MEMS spring and ECF; and bottom magnetic steel. The MEMS spring and ECF may be configured to flexibly electrically couple the camera image sensor and the RFPCB subassembly. The OIS drivers may be configured to control the OIS coils. The metal spring assembly may be subjected to a forming process to enhance the rigidity of the metal hinge assembly. The metal spring assembly may include one or more reinforcing ribs/folds.

In another implementation, an electromagnetic MEMS optical image stabilization camera module includes: a lens barrel assembly; an IR+magnet holder subassembly, wherein the IR+magnet holder subassembly includes: one or more magnet assemblies; a CIS+OIS subassembly, wherein the CIS+OIS subassembly includes: a camera image sensor; a metal spring assembly configured to enable planar motion of the camera image sensor, one or more OIS coils configured to enable planar movement of the metal spring assembly; and an RFPCB subassembly; wherein the CIS+OIS subassembly further includes: a MEMS spring and ECF configured to flexibly electrically couple the camera image sensor and the RFPCB subassembly.

One or more for the following features may be included. The lens barrel assembly may include one or more lens assemblies. The CIS+OIS subassembly may further include one or more of: an IR filter glass assembly; a holder assembly; and a top magnetic steel assembly. The IR filter glass assembly may be configured to filter IR light passing through the lens barrel assembly. The holder assembly may be configured to position the IR filter glass assembly with respect to the lens barrel assembly.

In another implementation, an electromagnetic MEMS optical image stabilization camera module includes: a lens barrel assembly; an IR+magnet holder subassembly, wherein the IR+magnet holder subassembly includes: one or more magnet assemblies; a CIS+OIS subassembly, wherein the CIS+OIS subassembly includes: a camera image sensor; a metal spring assembly configured to enable planar motion of the camera image sensor, and one or more OIS coils configured to enable planar movement of the metal spring assembly; and an RFPCB subassembly; wherein: the metal spring assembly is subjected to a forming process to enhance the rigidity of the metal hinge assembly, and the metal spring assembly includes one or more reinforcing ribs/folds.

One or more for the following features may be included. The lens barrel assembly may include one or more lens assemblies. The CIS+OIS subassembly may further include one or more of: an IR filter glass assembly; a holder assembly; and a top magnetic steel assembly. The IR filter glass assembly may be configured to filter IR light passing through the lens barrel assembly. The holder assembly may be configured to position the IR filter glass assembly with respect to the lens barrel assembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a perspective view of an electromagnetic MEMS optical image stabilization camera module in accordance with various embodiments of the present disclosure;

FIG. 2 is an exploded view of the electromagnetic MEMS optical image stabilization camera module of FIG. 1 in accordance with various embodiments of the present disclosure;

FIG. 3 is an exploded view of the IR+magnet holder subassembly of the electromagnetic MEMS optical image stabilization camera module of FIG. 1 in accordance with various embodiments of the present disclosure;

FIG. 4 is an exploded view of the CIS+OIS subassembly of the electromagnetic MEMS optical image stabilization camera module of FIG. 1 in accordance with various embodiments of the present disclosure;

FIG. 5 is a detail view of a metal spring assembly of the CIS+OIS subassembly of the electromagnetic MEMS optical image stabilization camera module of FIG. 1 in accordance with various embodiments of the present disclosure; and

FIG. 6 is an exploded view of the RFPCB subassembly 18 of the electromagnetic MEMS optical image stabilization camera module of FIG. 1 in accordance with various embodiments of the present disclosure.

Like reference symbols in the various drawings indicate like elements.

### DETAILED DESCRIPTION OF THE PREFERRED EMBODIMENTS

### System Overview

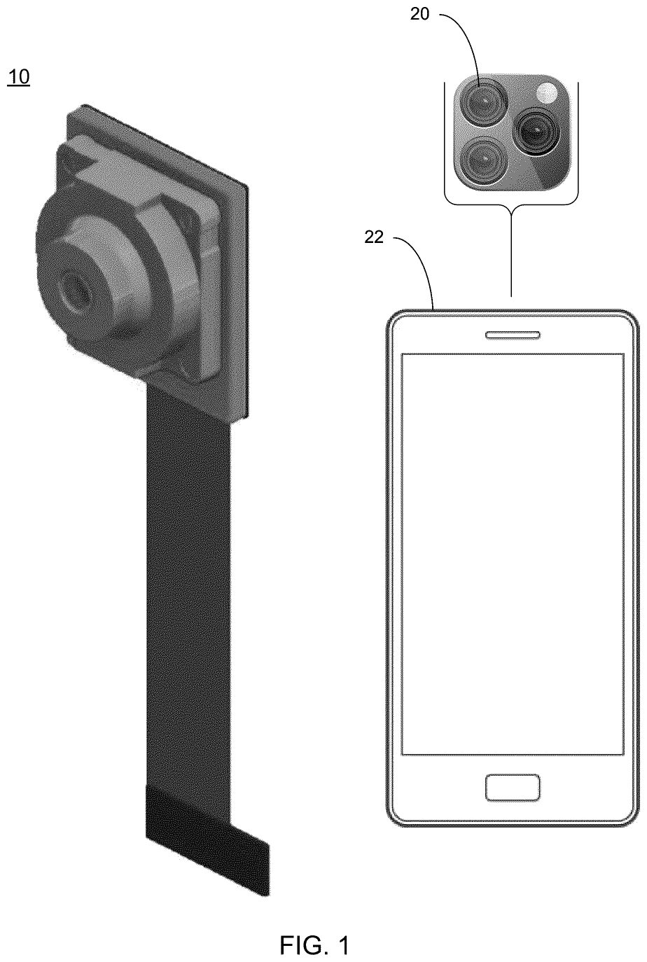

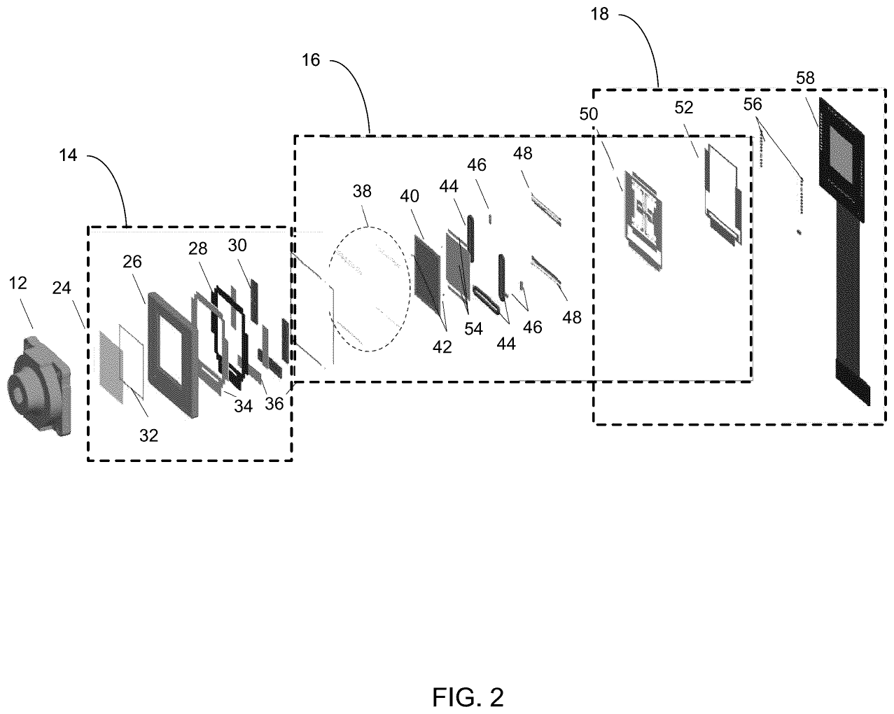

Referring to FIGS. 1-2, there is shown ElectroMagnetic (EM) MEMS Optical Image Stabilization (OIS) camera module 10, in accordance with various aspects of this disclosure. In this example, EM MEMS OIS camera module 10 is shown to include lens barrel assembly 12, IR+magnet holder subassembly 14, CIS+OIS subassembly 16, and RFPCB subassembly 18. In one implementation, EM MEMS OIS camera module 10 may be utilized within a camera assembly (e.g., camera assembly 20) included within a handheld electronic device (e.g., handheld electronic device 22), examples of which may include but are not limited to a cellular telephone.

Lens Barrel Assembly: Lens barrel assembly 12 may be a component of EM MEMS OIS camera module 10 within handheld electronic device 22. Lens barrel assembly 12 may house the camera lens and often includes other optical elements such as filters and apertures. The primary structure of the lens barrel assembly 12 may hold the individual lens elements in place, ensuring they are correctly aligned for optimal image capture. Within lens barrel assembly 12, multiple lenses may work together to focus light onto an image sensor, wherein these lenses may be constructed of glass or high-quality plastic. Lens barrel assembly 12 may include an aperture (i.e., a small opening that controls the amount of light entering the camera). Some lens barrel assemblies may have a fixed aperture, while others may feature an adjustable one. Lens barrel assembly 12 may be designed to be compact yet highly precise, reflecting the sophisticated nature of modern smartphone cameras.

IR+Magnet Holder Subassembly: IR+magnet holder subassembly 14 may be a component of EM MEMS OIS camera module 10 within handheld electronic device 22. IR+magnet holder subassembly 14 may be a specialized component that integrates an infrared filter and a magnet, playing an important role in the camera's functionality and image quality. An infrared filter may block infrared light from reaching the image sensor, ensuring that only visible light is captured, as infrared light may distort colors and degrade overall image quality. Meanwhile, a magnet holder may be part of the camera's autofocus or image stabilization system. In the autofocus mechanism, magnets may work with a magnetic coil to move various elements (e.g., an image sensor) precisely, thus ensuring sharp focus. In optical image stabilization (OIS), magnets may move the image sensor to counteract camera shake, thus reducing blur in photos and videos. By integrating both the IR filter and the magnet holder into a single subassembly, a compact and efficient design is realized (which is particularly important for small devices like smartphones). IR+magnet holder subassembly 14 may ensure precise alignment and secure placement of these critical components, thus enhancing the camera's performance and durability.

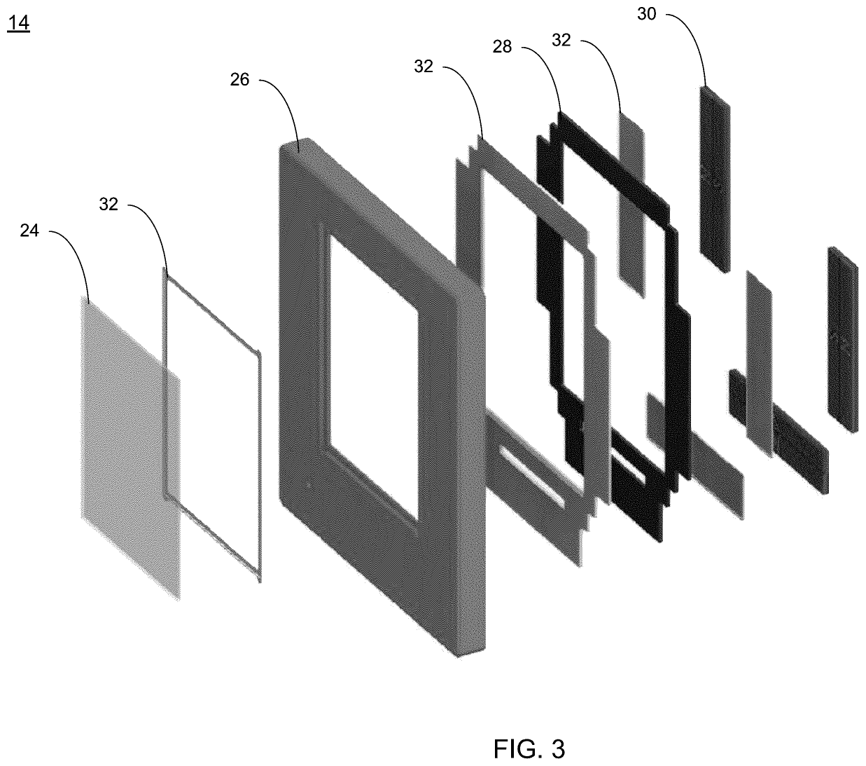

Referring also to FIG. 3, IR+magnet holder subassembly 14 may include IR filter glass assembly 24, holder assembly 26, top magnetic steel assembly 28, and magnet assemblies 30.

IR filter glass assembly 24 may be configured to filter infrared light that passes through lens barrel assembly 12. An IR (infrared) glass filter (e.g., IR filter glass assembly 24) in a camera assembly (e.g., camera assembly 20) is a specialized component designed to manage the passage of infrared light. In most consumer cameras, IR glass filters are used to block infrared light from reaching the camera sensor. This may be crucial because camera sensors are typically sensitive to a wide range of light, including both visible and infrared wavelengths. Without an IR filter, the sensor might capture unwanted infrared light, which may distort the colors and clarity of the images. By blocking infrared light, the IR filter ensures that the colors captured by the camera are accurate and true to life.

Holder assembly 26 may be configured to hold/position IR filter glass assembly 24 with respect to Lens Barrel Assembly 12. A holder assembly (e.g., holder assembly 26) in a camera assembly (e.g., camera assembly 20) is a structural component designed to securely hold and position various parts of the camera, ensuring proper alignment and stability. This holder assembly may include a lens holder, which keeps lens barrel assembly 12 in place and ensures it is correctly aligned with the camera sensor, vital for achieving clear and sharp images. Typically made from durable materials like metal or high-strength plastic, the holder assembly withstands physical stresses and environmental factors, keeping internal components stable and protected during use.

Top magnetic steel assembly 28 may be constructed of a magnetic material and may be configured to focus/direct magnetic flux toward magnet assemblies 30. Magnetic steel assemblies in a camera assembly (e.g., camera assembly 20) may serve a crucial role in several key mechanisms that ensure the camera functions effectively. Oftentimes found in autofocus systems, these components utilize magnetic fields to facilitate rapid and precise adjustments of the lens elements. This capability may enable the camera to achieve quick and accurate focusing on subjects, enhancing the overall usability and performance of the device. Additionally, magnetic steel components are often integral to image stabilization systems, where such a system may help stabilize the lens or sensor against camera shake by making real-time adjustments based on detected motion. This may result in sharper images and smoother videos, particularly in challenging shooting conditions.

When assembling IR+magnet holder subassembly 14, epoxy 32 may be applied to holder assembly 26 for affixing IR filter glass assembly 24. IR filter glass assembly 24 may then be placed within epoxy 32 applied to holder assembly 26, wherein epoxy 32 may then be allowed to cure. Epoxy 34 may be applied to holder assembly 26 for affixing top magnetic steel assembly 28. Top magnetic steel assembly 28 may then be placed within epoxy 34 applied to holder assembly 26, wherein epoxy 34 may then be allowed to cure. Epoxy 36 may be applied to top magnetic steel assembly 28 for affixing magnet assemblies 30. Magnet assemblies 30 may then be placed within epoxy 36 applied to top magnetic steel assembly 28, wherein epoxy 36 may then be allowed to cure.

CIS+OIS Subassembly: CIS+OIS subassembly 16 may be a component of EM MEMS OIS camera module 10 within handheld electronic device 22. CIS+OIS subassembly 16 may combine an image sensor and the stabilization mechanism to enhance photo and video quality. An image sensor may be responsible for capturing light and converting it into electronic signals, forming the basis of the digital image. High-quality image sensors may capture detailed and vibrant images, essential for modern smartphones. Optical image stabilization may compensate for hand movements and shakes during image capture and may work by adjusting the image sensor in real-time to counteract any motion, resulting in sharper images and smoother videos (which is essential in low-light conditions or during longer exposures). By integrating CIS and OIS into a single subassembly, smartphone manufacturers may save space and reduce the complexity of the camera module, thus allowing for slimmer device designs without compromising on image quality.

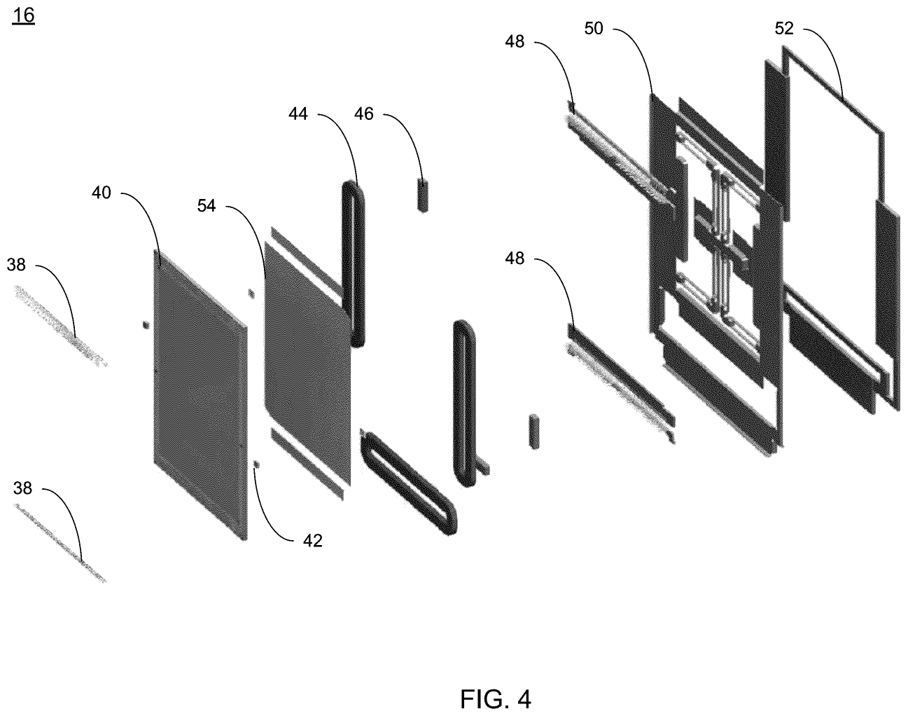

Referring also to FIG. 4, CIS+OIS subassembly 16 may include wire bonds 38, camera image sensor 40, moving magnetic steel 42, OIS coils 44, OIS drivers 46, MEMS spring and ECF 48, metal spring assembly 50, and bottom magnetic steel 52.

Wire bonds 38 are thin wires used to make electrical connections between the semiconductor chip and its external leads in integrated circuits and other microelectronic devices. They are essential in the packaging of microchips, ensuring that the chip can communicate with other components in a system. These wire bonds are typically made from gold, aluminum, or copper, each chosen for its excellent electrical conductivity and other properties suited to specific applications. There are two primary methods of wire bonding: ball bonding and wedge bonding. Ball bonding, primarily used for gold and copper wires, involves forming a small ball at the end of the wire using a flame or electronic discharge. This ball is then pressed onto the chip pad to make the connection. Wedge bonding, often used for aluminum wires, involves using a wedge-shaped tool to press the wire onto the chip pad without forming a ball. Both methods ensure a secure electrical connection between the chip and its package, playing a crucial role in the functionality and reliability of electronic devices.

Camera image sensor 40 is a component within a camera assembly (e.g., camera assembly 20) responsible for capturing light and converting it into electronic signals, which are then processed to form digital images. The primary function of the image sensor is to detect light that passes through the camera lens and hits its surface, which consists of millions of photosensitive elements called pixels. There are two main types of image sensors used in cameras: CCD (charge-coupled device) and CMOS (complementary metal-oxide-semiconductor). CCD sensors are known for their high-quality images and low noise, while CMOS sensors are more power-efficient and allow for faster image processing. The choice between these sensors may depend on the specific requirements of the camera, such as image quality, power consumption, and speed.

Moving magnetic steel 42 may be configured to allow the movement of camera image sensor 40 within a camera assembly (e.g., camera assembly 20), thus enabling autofocus functionality and/or optical image stabilization functionality.

OIS coils 44 and OIS drivers 46 collaborate as critical components designed to enhance image quality by minimizing the effects of camera shake and movement. OIS coils (e.g., OIS coils 44) are electromagnets strategically positioned within the camera lens or sensor assembly. Their primary function involves generating magnetic fields that interact with the camera's lens elements or sensor, allowing for precise adjustments in response to detected motion. Such an adjustment may help counteract hand tremors, vibrations, or other movements that can blur images, particularly in low-light conditions or when using telephoto lenses.

Complementing the OIS coils are specialized drivers (e.g., OIS drivers 46) responsible for controlling these electromagnets (e.g., OIS coils 44). These drivers (e.g., OIS drivers 46) may receive signals from sensors such as gyroscopes or accelerometers that detect the camera's orientation and movements. Based on this feedback, the drivers calculate the necessary adjustments and send corresponding electrical signals to the OIS coils (e.g., OIS coils 44). The coils then generate magnetic forces that move the sensor (e.g., camera image sensor 40) in real-time to compensate for detected motion. This dynamic stabilization mechanism ensures that the camera can capture sharp and clear images, even under challenging shooting conditions.

The integration of OIS coils (e.g., OIS coils 44) and drivers (e.g., OIS drivers 46) within the camera assembly (e.g., camera assembly 20) represents a sophisticated approach to improving image stability and quality. By actively stabilizing the sensor during exposure, OIS technology minimizes the risk of motion blur and allows photographers and videographers to achieve sharper results without relying solely on higher shutter speeds or tripod stabilization. This capability is especially valuable in mobile phones and compact cameras, where space constraints demand efficient and effective stabilization solutions to enhance overall user experience and image fidelity.

MEMS spring and electrically conductive flexures (ECF) 48 are integral components within camera assemblies, designed to facilitate both electrical connectivity and mechanical flexibility. These specialized components serve a dual purpose: they establish reliable electrical connections between various components within the camera assembly (e.g., camera assembly 20) while allowing for movement and adjustment. Typically made from materials such as conductive polymers, metals, or carbon-based materials, electrically conductive flexures ensure that electrical signals can pass through even when the components they connect are in motion. This flexibility may be crucial in camera assemblies (e.g., camera assembly 20) where lenses, sensors, and other mechanisms require precise positioning and adjustments for functions like autofocus and image stabilization. By integrating these flexures into flexible printed circuits (FPCs) or ribbon cables, manufacturers may ensure that the camera's internal components can move independently while maintaining essential electrical connections.

As is known in the art, a MEMS (Micro-Electro-Mechanical System) device is a miniature mechanical and electro-mechanical system that integrates mechanical elements, sensors, actuators, and electronics on a single silicon substrate through microfabrication technology. These devices are incredibly small, typically ranging from micrometers to millimeters in size, and they utilize principles from disciplines like mechanical engineering, electrical engineering, and material science. MEMS devices may be used in various applications such as sensors for detecting pressure, temperature, motion, and chemical substances, as well as actuators for positioning and controlling movements. Their compact size, low power consumption, and ability to be mass-produced make MEMS devices integral in modern technology, found in smartphones, automotive systems, medical devices, and many other fields requiring precise and responsive sensing and actuation capabilities.

Metal spring assembly 50 may be configured to mount (directly or indirectly) camera image sensor 40, wherein metal spring assembly 50 may be configured to allow for planer movement of camera image sensor 40, thus enabling optical image stabilization functionality of the camera assembly (e.g., camera assembly 20).

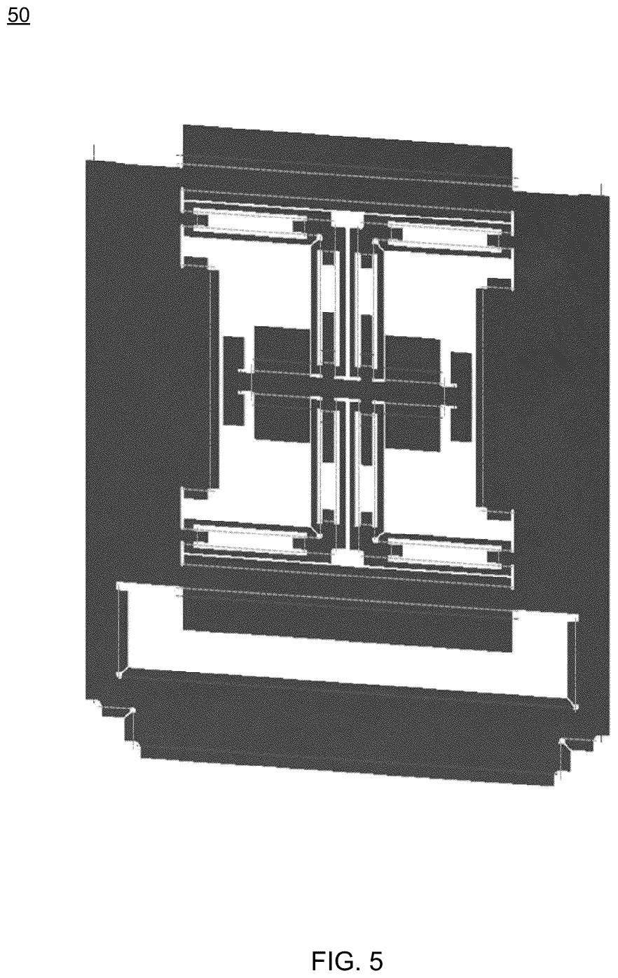

Referring also to FIG. 5, metal spring assembly 50 may be constructed by photochemically etching of thin metal plates to form springs and connected stages for MEMS products. This process allows for a great degree of design flexibility in creating complex planar geometries with high dimensional accuracy without additional cost. The addition of forming, stamping, or folding secondary operations may be added to give additional design flexibility for optimizing the strength and stiffness of a spring system. For a MEMS device, it may be desirable to reduce the size and mass of the overall device and in particular to reduce the moving payload. For a MEMS solution including an etched metal spring component, size and mass could be reduced by using a thinner metal plate to form metal spring assembly 50. This would come with the negative effect of reducing the strength and stiffness of metal spring assembly 50 compared to a similar component formed from a thicker initial metal plate. However, by incorporating a forming (e., bending or folding) secondary process after the etching, the structural strength of metal spring assembly 50 may be maintained while still achieving the reduction in size and mass and the desired out-of-plane geometry. For example and during such a forming process, reinforcing ribs or folds (shown as dashed lines) may be pressed into metal spring assembly 50 to provide a desired level of rigidity to metal spring assembly 50.

Bottom magnetic steel 52 may be constructed of a magnetic material and may be configured to focus/direct magnet flux toward OIS coils (e.g., OIS coils 44). As discussed above, magnetic steel assemblies in a camera assembly (e.g., camera assembly 20) may serve a crucial role in several key mechanisms that ensure the camera functions effectively. Oftentimes found in autofocus systems, these components utilize magnetic fields to facilitate rapid and precise adjustments of the lens elements. This capability may enable the camera to achieve quick and accurate focusing on subjects, enhancing the overall usability and performance of the device. Additionally, magnetic steel components are often integral to image stabilization systems, where such a system may help stabilize the lens or sensor against camera shake by making real-time adjustments based on detected motion. This may result in sharper images and smoother videos, particularly in challenging shooting conditions

When assembling CIS+OIS subassembly 16, OIS drivers (e.g., OIS drivers 46) may be surface mounted to metal spring assembly 50. Epoxy 54 may be dispensed onto metal spring assembly 50. OIS coils 44 and moving magnetic steel 42 may then be placed within epoxy 54 applied to metal spring assembly 50, wherein epoxy 54 may then be allowed to cure. OIS coils 44 may be soldered to metal spring assembly 50. Bottom magnetic steel 52 and metal spring assembly 50 may be placed in a jig assembly (not shown). Epoxy 54 may be dispensed onto bottom magnetic steel 52/metal spring assembly 50 subassembly. MEMS spring and electrically conductive flexures (ECF) 48 may then be placed within epoxy 54 applied to bottom magnetic steel 52/metal spring assembly 50 subassembly, wherein epoxy 54 may then be allowed to cure. Epoxy 54 may be dispensed onto this subassembly and camera image sensor 40 may be placed within epoxy 54 applied to this subassembly, wherein epoxy 54 may then be allowed to cure. Camera image sensor 40 may be wirebound to MEMS spring and electrically conductive flexures (ECF) 48; and MEMS spring and electrically conductive flexures (ECF) 48 may be wirebound to metal spring assembly 50.

RFPCB Subassembly: RFPCB (Rigid-Flex Printed Circuit Board) subassembly 18 may be a component of EM MEMS OIS camera module 10 within handheld electronic device 22 and may integrate both rigid and flexible sections to support the complex electronic components and connectivity required in the compact and intricate design of modern smartphone cameras. RFPCB (Rigid-Flex Printed Circuit Board) subassembly 18 may provide several advantages that are particularly beneficial for the high-performance demands of cell phone cameras. The rigid sections of the RFPCB may offer a stable platform for mounting critical components such as the camera image sensor (CIS), lens modules, and other integrated circuits that require precise alignment and minimal movement. These rigid parts may ensure structural integrity and reliable electrical connections. The flexible sections, on the other hand, may offer versatility in routing electrical signals between different parts of the camera module and the main motherboard of the phone. This flexibility may allow the camera assembly to be folded and bent to fit into the limited and often irregular spaces within the phone's housing. By combining these rigid and flexible elements, RFPCB (Rigid-Flex Printed Circuit Board) subassembly 18 may enhance the overall performance and reliability of the camera.

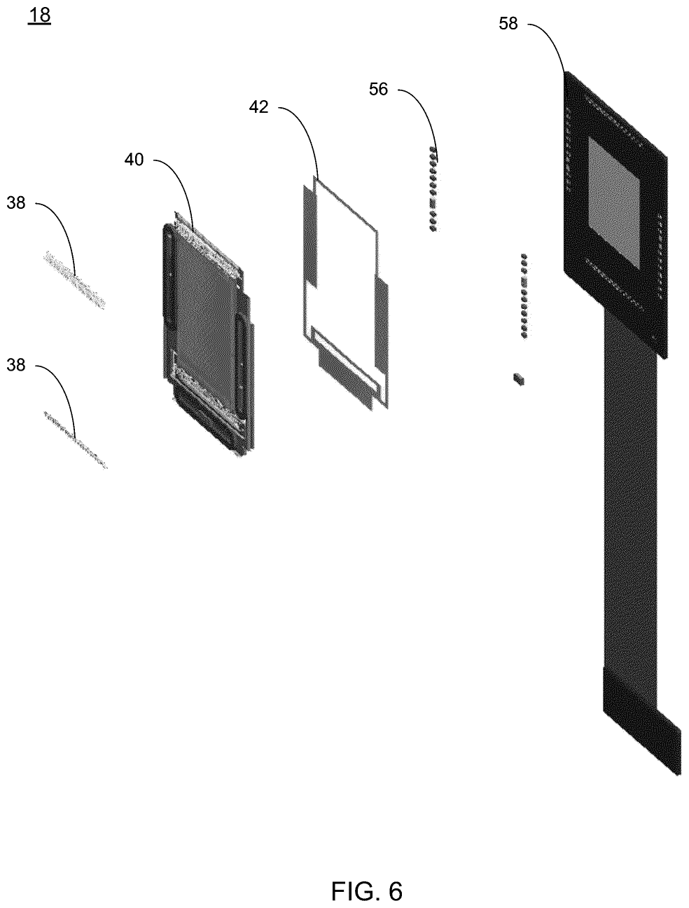

Referring also to FIG. 6, RFPCB (Rigid-Flex Printed Circuit Board) subassembly 18 may include component integrated circuits 56 (e.g., those circuits required for the operation of EM MEMS OIS camera module 10) and RFPCB (Rigid-Flex Printed Circuit Board) 58.

When assembling RFPCB (Rigid-Flex Printed Circuit Board) subassembly 18, component integrated circuits 56 may be surface mounted to RFPCB 58. Epoxy 54 may be dispensed onto RFPCB 58. CIS+OIS subassembly 16 may then be placed into epoxy 54 applied to RFPCB 58, wherein epoxy 54 may then be allowed to cure. MEMS spring and electrically conductive flexures (ECF) 48 may be wirebound to RFPCB 58.

### General:

In general, the various operations of method described herein may be accomplished using or may pertain to components or features of the various systems and/or apparatus with their respective components and subcomponents, described herein.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. An electromagnetic MEMS optical image stabilization camera module comprising:
a lens barrel assembly;
an IR+magnet holder subassembly, wherein the IR+magnet holder subassembly includes:
one or more magnet assemblies;
a CIS+OIS subassembly, wherein the CIS+OIS subassembly includes:
a camera image sensor;
a metal spring assembly configured to enable planar motion of the camera image sensor, and
one or more OIS coils configured to enable planar movement of the metal spring assembly; and
an RFPCB subassembly.

2. The electromagnetic MEMS optical image stabilization camera module of claim 1 wherein the lens barrel assembly includes one or more lens assemblies.

3. The electromagnetic MEMS optical image stabilization camera module of claim 1 wherein the CIS+OIS subassembly further includes one or more of:
an IR filter glass assembly;
a holder assembly; and
a top magnetic steel assembly.

4. The electromagnetic MEMS optical image stabilization camera module of claim 3 wherein the IR filter glass assembly is configured to filter IR light passing through the lens barrel assembly.

5. The electromagnetic MEMS optical image stabilization camera module of claim 4 wherein the holder assembly is configured to position the IR filter glass assembly with respect to the lens barrel assembly.

6. The electromagnetic MEMS optical image stabilization camera module of claim 1 wherein the IR+magnet holder subassembly further includes one or more of:
wire bonds;
moving magnetic steel;
OIS drivers;
MEMS spring and ECF; and
bottom magnetic steel.

7. The electromagnetic MEMS optical image stabilization camera module of claim 6 wherein the MEMS spring and ECF is configured to flexibly electrically couple the camera image sensor and the RFPCB subassembly.

8. The electromagnetic MEMS optical image stabilization camera module of claim 6 wherein the OIS drivers are configured to control the OIS coils.

9. The electromagnetic MEMS optical image stabilization camera module of claim 1 wherein the metal spring assembly is subjected to a forming process to enhance the rigidity of the metal hinge assembly.

10. The electromagnetic MEMS optical image stabilization camera module of claim 1 wherein the metal spring assembly includes one or more reinforcing ribs/folds.

11. An electromagnetic MEMS optical image stabilization camera module comprising:
a lens barrel assembly;
an IR+magnet holder subassembly, wherein the IR+magnet holder subassembly includes:
one or more magnet assemblies;
a CIS+OIS subassembly, wherein the CIS+OIS subassembly includes:
a camera image sensor;
a metal spring assembly configured to enable planar motion of the camera image sensor,
one or more OIS coils configured to enable planar movement of the metal spring assembly; and
an RFPCB subassembly;
wherein the CIS+OIS subassembly further includes:
a MEMS spring and ECF configured to flexibly electrically couple the camera image sensor and the RFPCB subassembly.

12. The electromagnetic MEMS optical image stabilization camera module of claim 11 wherein the lens barrel assembly includes one or more lens assemblies.

13. The electromagnetic MEMS optical image stabilization camera module of claim 11 wherein the CIS+OIS subassembly further includes one or more of:
an IR filter glass assembly;
a holder assembly; and
a top magnetic steel assembly.

14. The electromagnetic MEMS optical image stabilization camera module of claim 13 wherein the IR filter glass assembly is configured to filter IR light passing through the lens barrel assembly.

15. The electromagnetic MEMS optical image stabilization camera module of claim 14 wherein the holder assembly is configured to position the IR filter glass assembly with respect to the lens barrel assembly.

16. An electromagnetic MEMS optical image stabilization camera module comprising:
a lens barrel assembly;
an IR+magnet holder subassembly, wherein the IR+magnet holder subassembly includes:
one or more magnet assemblies;
a CIS+OIS subassembly, wherein the CIS+OIS subassembly includes:
a camera image sensor;
a metal spring assembly configured to enable planar motion of the camera image sensor, and
one or more OIS coils configured to enable planar movement of the metal spring assembly; and
an RFPCB subassembly;
wherein:
the metal spring assembly is subjected to a forming process to enhance the rigidity of the metal hinge assembly, and
the metal spring assembly includes one or more reinforcing ribs/folds.

17. The electromagnetic MEMS optical image stabilization camera module of claim 16 wherein the lens barrel assembly includes one or more lens assemblies.

18. The electromagnetic MEMS optical image stabilization camera module of claim 16 wherein the CIS+OIS subassembly further includes one or more of:
an IR filter glass assembly;
a holder assembly; and
a top magnetic steel assembly.

19. The electromagnetic MEMS optical image stabilization camera module of claim 18 wherein the IR filter glass assembly is configured to filter IR light passing through the lens barrel assembly.

20. The electromagnetic MEMS optical image stabilization camera module of claim 19 wherein the holder assembly is configured to position the IR filter glass assembly with respect to the lens barrel assembly.
